(19) United States
(12) Patent Application Publication
(10) Pub. No.: US 2004/0159677 A1
(43) Pub. Date: Aug. 19, 2004

(54) Cosmetic material vessel for automatically mixing and precisely dispensing the contents with a desired quantity

(75) Inventor: Jae Kwang Hwang, Seoul (KR)

Correspondence Address: BURNS DOANE SWECKER & MATHIS L L P, POST OFFICE BOX 1404, ALEXANDRIA, VA, 22313-1404, US

(73) Assignee: F.S. Korea Industries, Inc.

(21) Appl. No.: 10/777,171

(22) Filed: Feb. 13, 2004

(30) Foreign Application Priority Data
Feb. 17, 2003 (KR) 10-2003-0009744

(51) Int. Cl. B67D 5/60

(52) U.S. Cl. 222/145.5

(57) ABSTRACT

Disclosed is an apparatus capable of precisely feeding contents at a desired quantity by discharging and then mixing the contents, which are separately stored in double chambers, on the basis of a difference in pressure between double chambers in a state that an atmospheric air pressure is applied to the cosmetic material vessel. A circular connecting member is disposed between an inner highest portion of the lower case and the inner lower portion of the upper case. The discharge tubes extend from the first and the second chambers through the inside of the connecting member into the upper case. The highest upper free ends of the discharge tubes are inserted into the body of a discharge-quantity control part disposed at an internal center portion of the upper case. A valve is rotatably disposed between the highest upper free ends of the discharge tubes within the body. The valve is integrally connected with a dial disposed between the valve and the circular connecting member in such a manner as to operate together with the dial. The valve selectively opens or closes the highest upper ends of the discharge tubes by receiving a driving force from the dial. A vacuum prevention cap is disposed at a horizontal partition and allows an external air to be introduced into the first chamber and the second chamber and stops the contents from discharging so as to offset an atmospheric air pressure difference being generated during discharging contents from the first and the second chambers. Sealing members are disposed among the upper surfaces, the lower surfaces of the connecting member and outer circumferential surfaces of the discharge tubes.

### BACKGROUND OF THE INVENTION

1. Field of the Invention

The present invention relates to a cosmetic material vessel, more particularly to a cosmetic material vessel capable of precisely dispensing contents at a desired quantity by discharging and then mixing the contents, which are separately stored in double chambers, on the basis of a pressure's difference between the double chambers in a state that an atmospheric air pressure is applied to the cosmetic material vessel, in which new cosmetic material can easily be refilled in the cosmetic material vessel, which is convenient to use and can be manufactured at a low cost.

2. Description of the Related Art

Conventionally, certain contents, which can be in a liquid phase or a gel-phase, are commercially on sale in such a manner that they are charged into a certain vessel such as a bottle. These contents are discharged to the outside of the bottle due to pumping operation of a pumping device such as a piston installed in the bottle. Accordingly, there are variety endeavors for improving the internal structure of the pumping device so as to facilitate for use the bottle.

FIG. 4 shows an internal structure of the cosmetic material vessel according to the prior art.

As shown in FIG. 4, the first and the second chambers 11, 12 for containing different contents such as a liquid phase of content or a gel-shape of content are formed in a cosmetic material vessel 10. For example, a liquid phase of content or a gel-shape of content such as a sun tan lotion having a different concentration may be separately contained in the first chamber 11 and the second chamber 12.

For this purpose, a disk-shaped lower sealing member 13 is slideably disposed in the first chamber 11 and the second chamber 12, respectively in such a manner as to slideably move upwards and downwards therein. Bottom surfaces of the first and second chambers 11, 12 are sealed by means of a lower cover, respectively. In order to fill a liquid phase of content or a gel-shape of content in the first and second chambers 11, 12 from the lower side of the cosmetic material vessel 10, it is required to open a lower cover 14 and then to temporarily remove the lower sealing member 13 from the first and second chambers 11, 12.

After completion of refilling new cosmetic material therein, the lower sealing member 13 may be located at the lowest position within the first and second chambers 11, 12.

An upper wall 15 is formed at upper portions of the first and second chambers 11, 12, respectively and it is radially inwardly slanted there from in the downward direction. A discharge port 15a is provided at a center portion of the upper wall 15. A lower end of an upper sealing member 16 is inserted into the discharge port 15a. Lower portions of cylindrical operating rods 18a, 18b are integrally connected with the center portions of the upper sealing member 16. At this time, a ball-shaped bearing member 17 is disposed at the joint position between the upper sealing member 16 and the cylindrical operating rods 18a, 18b, respectively.

Vertical extending portions 19a, 19b are formed at upper portions of the cylindrical operating rods 18a, 18b and hose-shaped feeding pipes 31a, 31b upwardly extend from the upper portions of the vertical extending portions 19a, 19b. Upper ends of the hose-shaped feeding pipes 31a, 31b are coupled to a lower portion of a push button 32 disposed at the highest portion of the cosmetic material vessel 10. At this time, the feeding pipes 31a, 31b are communicated with a cosmetic material discharge port 33.

In the meantime, a discharge-quantity control part 20 is disposed between the cylindrical operating rods 18a, 18b. The discharge-quantity control part 20 is provided with a control stage 21. At this time, both ends of the discharge-quantity control part 20 are integrally connected with the cylindrical operating rods 18a, 18b, respectively.

The operation of the cosmetic material vessel according to the prior art will subsequently be described.

If a user wants to use at least two preparation cosmetic material components of which at least one is a liquid phase and the other is a gel-like phase, which are separate from one another in the first and the second chambers 11, 12, the user can discharge the cosmetic materials by operating a control switch (the identical numerals are omitted) of the discharge-quantity control part 20 and can control the discharging amount of the contents by rotating the control switch in the clockwise direction or the counter-clockwise direction.

For example, if the control switch of the discharge-quantity control part 20 is rotated at a predetermined rotational angle in the leftward direction with respect to the drawings, the control stage 21 of the discharge-quantity control part 20 is moved in the leftward direction with respect to the drawings, and thereby the second operating rod 18b is slanted toward the first operating rod 18a. At this time, the second vertical extending portion 19b located at the upper side of the second operational rod 18b and the second feeding pipe 31b are also moved leftwards. As a result, the degree of communication between the lower portion of the push button 32 and the second feeding pipe 31b becomes smaller. Under this state, if the user pushes down the push button 32, the cosmetic materials stored in the first chamber 11 and the second chamber 12 begin to be discharged. At this time, the amount of the cosmetic material discharged from the first chamber 11 is greater than that of the cosmetic material discharged from the second chamber 12. The cosmetic material discharged from the first and the second chambers 11, 12 through the feeding pipes 31a, 31b have to be mixed together immediately prior to feed at the lower portion of the push button 32 and then feed through the cosmetic material discharge port 33.

If the control switch of the discharge-quantity control part 20 is fully rotated in the leftward direction with respect to the drawings, the control stage 21 of the discharge-quantity control part 20 is fully moved in the leftward direction with respect to the drawings, and thereby the second feeding pipe 31b cannot be communicated with the lower portion of the push button 32. As a result, the cosmetic material contained in the second chamber 12 cannot be discharged and only the cosmetic material contained in the first chamber 11 can be discharged.

Alternatively, if the control switch of the discharge-quantity control part 20 is partially or fully rotated in the rightward direction with respect to the drawings, the cosmetic material stored in the second chamber 12 can be discharged with an amount greater than that of the cosmetic material contents stored in the first chamber 11 or can be only discharged.

In the meantime, when the cosmetic materials stored in the first chamber 11 and/or the second chamber 12 are exhausted, it is required to remove the lower cover 14 so as to refill new cosmetic material in the cosmetic material vessel 10. After removing the lower cover 14 and temporarily disengaging the lower sealing members 13 from the first chamber 11 and the second chamber 12, new cosmetic materials may be filled in the first chamber 11 and/or the second chamber 12 so as to reuse the cosmetic material vessel 10.

However, there is one problem that sealing power at joints among the discharge port 15a formed at the upper wall 15, the upper sealing members 16a, 16b adjacent to the discharge port 15a, and the operating rods 18a, 18b becomes weak and thereby the cosmetic material contained in the cosmetic material vessel 10 may leak. There is other problem that the lower sealing member 13 disposed in the first and the second chambers 11, 12 does not frequently operate and thereby it is impossible to completely seal the insides of the first and the second chambers 11, 12. Consequently, it is inconvenient to use the cosmetic material vessel. Another problem associated with the conventional cosmetic vessel 10 is that a processing error may be incurred during manufacture of the lower sealing member 13 and thereby a difference of frictional force between the first chamber 11 and the second chamber 12 may be created during operation of the lower sealing member 13. This does not allow for the discharging of the cosmetic material with a desired quantity.

### SUMMARY OF THE INVENTION

The present invention is made in consideration of the problems described above. It is an object of the present invention to provide an automatic mixing cosmetic material vessel capable of precisely dispensing contents at a desired quantity by discharging and then mixing the contents, which are separately stored in double chambers, on the basis of a pressure's difference between the double chambers in a state that an atmospheric air pressure is applied to the cosmetic material vessel.

Furthermore, it is other object of the present invention to provide an automatic mixing cosmetic material vessel in which new cosmetic material can easily be refilled in the cosmetic material vessel, which is convenient to use, by making an outer case with a transparent material and by permitting an upper case to easily be disengaged from a lower case so as to refill new cosmetic material.

Furthermore, it is another object of the present invention to provide an automatic mixing cosmetic material vessel capable of easily being manufactured, which has a low manufacturing cost.

In order to achieve the above objects, the present invention provides an automatic mixing cosmetic material vessel having an upper case, a lower case and a discharge pump disposed at a position above the upper case, in which a first and a second chambers for containing contents therein are formed in the lower case, parts of discharge tubes are disposed in the first and the second chambers and a horizontal partition is disposed at an upper inner side of the lower case, characterized by comprising:

a circular connecting member being disposed between an inner highest portion of the lower case and an inner lower portion of the upper case;

the discharge tubes extending from the first and the second chambers through an inside of the connecting member into the upper case;

the highest upper free ends of the discharge tubes being inserted into a body of a discharge-quantity control part disposed at an internal center portion of the upper case; and

a valve being rotatably disposed between the highest upper free ends of the discharge tubes within the body,

wherein, the valve is integrally connected with a dial disposed between the valve and the circular connecting member in such a manner as to operate together with the dial, and the valve selectively opens or closes the highest upper ends of the discharge tubes by receiving a driving force from the dial.

An opening is formed through the horizontal partition. A vacuum prevention cap is fitted into the opening and allows an external air to be introduced into the first chamber and the second chamber and stops the contents from discharging so as to offset an atmospheric air pressure difference being generated during discharging contents from the first and the second chambers.

Sealing members for preventing the contents in the cosmetic material vessel from leaking are disposed between the upper surfaces of the connecting member and outer circumferential surfaces of the discharge tubes passing through the inside of the connecting member and between the lower surfaces of the connecting member and outer circumferential surfaces of the discharge tubes.

As described above, in the automatic mixing cosmetic material vessel according to the present invention, the discharge pump operates under the state that an atmosphere air pressure can be maintained in the cosmetic material vessel, wherein it is possible to accurately feed the cosmetic materials at a desired quantity.

Since the sealing members made of a silicon-based material are disposed at the joint positions around the discharge tube, it is possible to prevent the contents from leaking by disposing a sealing member.

### BRIEF DESCRIPTION OF THE DRAWINGS

The above object, other characteristics and advantages of the present invention will become more apparent by describing in detail a preferred embodiment thereof with reference to the attached drawings, in which:

FIG. 1 shows an internal structure of the automatic mixing cosmetic material vessel according to the preferred embodiment of the present invention,

FIG. 2 is a side view of the cosmetic material vessel as shown in FIG. 1,

FIG. 3 is a partial enlarged view of the cosmetic material vessel illustrated in FIG. 1, and

FIG. 4 shows an internal structure of the cosmetic material vessel according to the prior art.

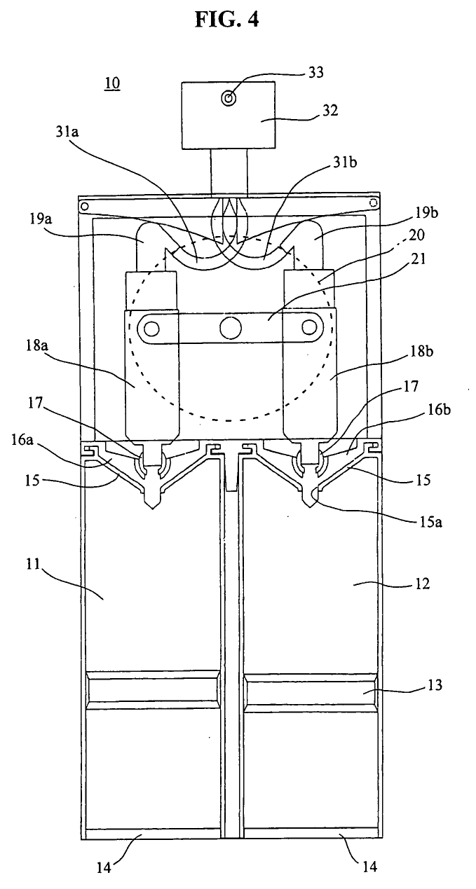

### DETAILED DESCRIPTION OF THE INVENTION

Hereinafter, the cosmetic material vessel according to the preferred embodiment of the present invention will be explained in more detail with reference to the accompanying drawings.

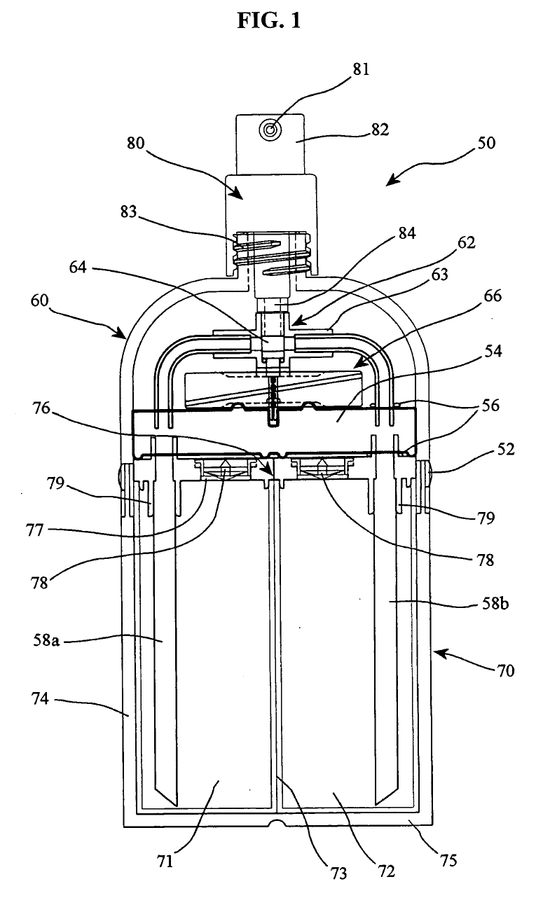

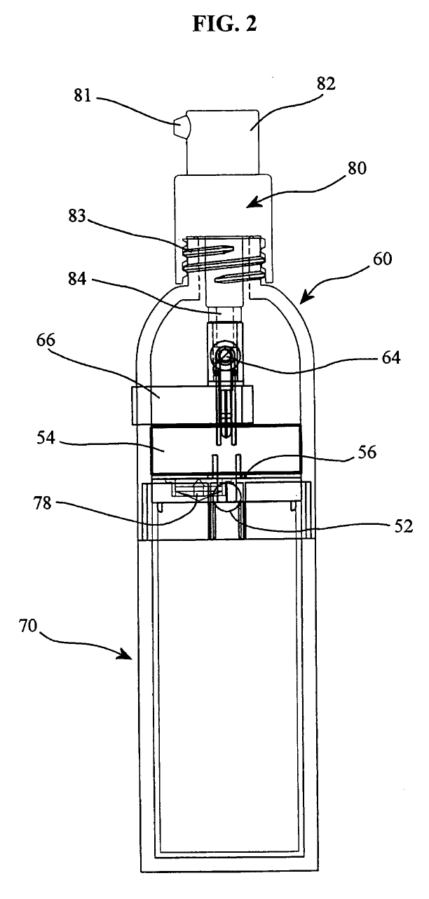

FIG. 1 shows an internal structure of the automatic mixing cosmetic material vessel according to the preferred embodiment of the present invention. FIG. 2 is a side view of the cosmetic material vessel as shown in FIG. 1.

Referred to FIGS. 1 and 2, the cosmetic material vessel 50 according to the preferred embodiment of the present invention mainly includes an upper case 60, a lower case 70 and a discharge pump 80 disposed at a position adjacent to the upper case 60. Preferably, the lower case 70 is made of a transparent plastic material so that the user can see the inside of the lower case 70.

A first chamber 71 and a second chamber 72 for containing at least two preparation components of which at least one is a liquid phase and the other is a gel-like phase are formed in the cosmetic material vessel 50. More precisely, an internal space is defined by sidewalls 74 and a bottom wall 75 within the lower case 70 of the cosmetic material vessel 50 and is divided into the first chamber 71 and the second chamber 72 by means of a vertical partition 73. At least two preparation components of which at least one is a liquid phase and the other is a gel-like phase such as a sun tan lotion are separate from one another in the first chamber 71 and the second chamber 72 so as to reliably prevent undesired chemical reactions.

A horizontal partition 76 is disposed at an upper inner side of the lower case 70. An upper end of the vertical partition 73 for dividing the inner space of the lower case 70 into the first chamber 71 and the second chamber 72 is integrally fixed to a center lower portion of the horizontal partition 76. Two openings 77 are formed through the horizontal partition 76 at positions above the first chamber 71 and the second chamber 72. Vacuum prevention caps 78 are fitted into the openings 77, respectively. The vacuum prevention cap 78 has a function of maintaining internal atmospheric pressures in the first chamber 71 and the second chamber 72. For this purpose, the vacuum prevention cap 78 allows an external air to be introduced into the first chamber 71 and the second chamber 72 and stops the contents from discharging so that a difference in atmospheric pressure that is created during the discharge of the contents contained the first chamber 71 and the second chamber 72 is settled.

Discharge tube fitting holes 79 are formed through the horizontal partition 76 at radial outside positions of the vacuum prevention cap 78. Middle portions of the discharge tubes 58a, 58b are fitted into the discharge fitting hole 79. Lower portions of the discharge tubes 58a, 58b vertically downwardly extend within the first chamber 71 and the second chamber 72. Lower ends of the discharge tubes 58a, 58b are close to bottom inner surfaces of the first chamber 71 and the second chamber 72.

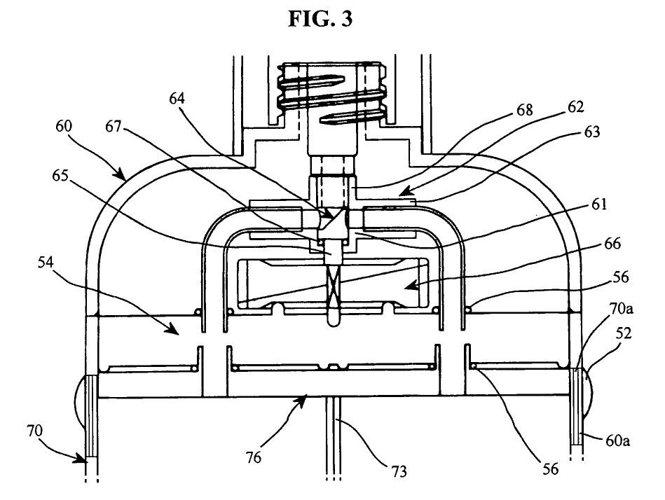

FIG. 3 is a partial enlarged view of the cosmetic material vessel illustrated in FIG. 1.

As shown in FIG. 3, the upper case 60 is engaged with the lower case 70 in such a manner that the upper case 60 can easily be attached to and detached from the lower case 70. For this purpose, fitting protrusions 70a protrude from upper ends of radial sidewalls of the lower case 70 and fitting grooves 60a are formed at lower inner sides of the radial sidewalls of the upper case 60.

When the upper case 60 and the lower case 70 are engaged with each other, the fitting protrusions 70a of the lower case 70 are fitted into the fitting grooves 60a of the upper case 60. Release buttons 52 radially outwardly protrude from connecting portions between the upper ends of the radial sidewall of the lower case 70 and the lower ends of the radial sidewall of the upper case 60. Accordingly, the upper case 60 and the lower case 70 can be easily separated from each other so as to refill new content in the cosmetic material vessel 50.

Meanwhile, a circular connecting member 54 is disposed between an inner highest portion of the lower case 70 and the inner lower portion of the upper case 60. The middle portions of the discharge tubes 58a, 58b extending to the outside of the first chamber 71 and the second chamber 72 pass through the inside of the connecting member 54.

At this time, O-rings 56 made of a silicon material are disposed between the upper surfaces of the connecting member 54 and the outer circumferential surfaces of the discharge tubes 58a, 58b and between the lower surfaces of the connecting member 54 and the outer circumferential surfaces of the discharge tubes 58a, 58b. The sealing ring 56 has a function of preventing the contents in the cosmetic material vessel 50 from leaking between the connecting member 54 and the outer circumferential surfaces of the discharge tubes 58a, 58b.

Meanwhile, the discharge tubes 58a, 58b extending toward the inside of the upper case 60 continuously extend upwards at a predetermined length and then be radially inwardly rounded. The rounded free ends of the discharge tubes 58a, 58b are connected to a discharge-quantity control part 62 disposed at the center in the upper case 60. To be more precise, the highest end portions of the discharge tubes 58a, 58b are fitted into first protrusions 63 radially outwardly extending from a body 61 of the discharge-quantity control part 62. A valve 64 is rotatably disposed between the highest end portions of the discharge tubes 58a, 58b fitted into the body 61.

The valve 64 is connected with a disc-shaped dial 66 via a vertical rotational shaft 65 vertically extending from the lower portion of the valve 64. In more detail, the vertical rotational shaft 65 passes through the inside of the dial 66. At this time, the lower end of the rotational shaft 65 is inserted into the circular connecting member 54. Accordingly, the valve 64 can receive a rotational force of the dial 66 via the vertical rotational shaft 65 and thereby it can be moved in cooperation with the dial 66. A part of the dial 66 is exposed to the outside of the upper case 60 so that the user can access to the dial 66. A bearing 67 for supporting a smooth rotation of the rotational shaft 65 is disposed between the valve 64 and the rotational shaft 65.

In the meantime, the discharge pump 80 is disposed at a predetermined position above the valve 64. A part of the discharge pump 80 is exposed to the outside of the upper case 60 and the other is positioned in the upper case 60. A push button 82 is disposed at an upper portion of the discharge pump 80 and a discharge port 81 is formed at a middle portion of the push button 82. The push button 82 is elastically supported by a coil spring 83 disposed in a neck portion of the upper case 60. A content discharge passageway 84 is formed in the push button 82. Since the lower portion of the push button 82 is inserted into a second protrusion 68 upwardly protruding from the body 61 of the discharge-quantity control part 62, the content discharge passageway 84 is communicated with the valve 64 disposed in the body 61.

The operation of the cosmetic material vessel according to the preferred embodiment of the present invention will subsequently be described with reference to the accompanying drawings.

If a user wants to use at least two preparation cosmetic material components of which at least one is a liquid phase and the other is a gel-like phase, which are separate from one another in the first and the second chambers 71, 72, the user can discharge the cosmetic materials by operating the discharge pump 80. Prior to operating the discharge pump 80, it is required to control the feeding amount of the cosmetic materials by rotating the dial 66 of which a part is exposed to the outside of the upper case 60.

For example, if the dial 66 is rotated at a predetermined rotational angle in leftward direction with respect to the drawings so as to discharge the cosmetic materials stored in the first chamber 71 with an amount greater than that of the second chamber 72, the valve 64 which is in cooperation with the dial 66 via the vertical rotational shaft 65 is rotated in the clockwise direction or the counter-clockwise direction by receiving the rotational force from the dial 66. At this time, the valve 64 partly closing the upper free end of the first discharge tube 58a permits the first discharge tube 58a to be more open. Under this state, if the user pushes down the push button 82 of the discharge pump 80, the cosmetic materials stored in the first and the second chambers 71, 72 begin to be discharged. At this time, the amount of the cosmetic material discharged from the first chamber 71 is greater than that of the cosmetic material discharged from the second chamber 72.

The contents discharged into the discharge-quantity control part 62 through the discharge tubes 58a, 58b from the first and the second chambers 71, 72 are mixed at a position adjacent to the valve 64 and then the mixtures are upwardly transferred through the content discharge passageway 84 in the discharge pump 80. Thereafter, the cosmetic material mixtures are discharged to the outside via the discharge port 81. At this time, since the contents are completely discharged from the first and the second chambers 71, 72, the atmosphere air pressure in the first and the second chambers 71, 72 becomes lower. Since external air is introduced into the first and the second chambers 71, 72 via the vacuum prevention cap 78, a certain air pressure can be maintained for next discharge of the cosmetic material.

If the dial 66 is fully rotated in the leftward direction with respect to the drawings, the valve 64 is rotated in the clockwise direction or the counter-clockwise direction by receiving the rotational force from the dial 66. At this time, the valve 64 permits the highest upper end of the first discharge tube 58a to be fully open and completely closes the upper portion of the second discharge tube 58b. Under this state, if the user pushes down the push button 82 of the discharge pump 80, only the contents stored in the first chamber 71 can be discharged into the discharge-quantity control part 62 and then it is continuously transferred upwards through the content discharge passageway 84 of the discharge pump 80. Consequently, it is discharged to the outside of the cosmetic material vessel 50 via the discharge port 81.

Alternatively, if the dial 66 is partially or fully rotated in the rightward direction with respect to the drawings, the cosmetic material contents stored in the second chamber 72 can be discharged with an amount greater than that of the cosmetic material contents stored in the first chamber 71. Also, the contents contained in the second chamber 72 are only discharged. However, other operational process is similar to the process described above in such a manner that the dial 66 is rotated in the leftward direction with respect to the drawings and therefore the detailed description will be omitted.

Alternatively, if the dial 66 is positioned at a middle point, the contents separately stored in the first chamber 71 and the second chamber 72 can be discharged at a uniform quantity, respectively.

In the meantime, when the cosmetic materials stored in the first chamber 71 and/or the second chamber 72 are exhausted, it is required to release the integral connection between the upper case 60 and the lower case 70. After disengaging the upper case 60 from the lower case 70, new cosmetic materials may be filled in the first chamber 71 and/or the second chamber 72 within the lower case 70 so as to reuse the cosmetic material vessel 50.

As described above, the automatic mixing cosmetic material vessel 50 operates under the state that an atmosphere air pressure can be maintained in the cosmetic material vessel 50, as contrary to the conventional cosmetic vessel 10, wherein it is possible to highly reduce the possibility of operational error that was in serious question in the conventional cosmetic material vessel 50. Accordingly, it is possible to accurately discharge the cosmetic materials at a desired quantity. Since the number of constitutional parts of the cosmetic material vessel is reduced, it can easily be manufactured and the production costs can be reduced. In addition, it is possible to prevent the contents from leaking by disposing a sealing member made of a silicon-based material at the joint position around the discharge tube.

While the present invention has been particularly shown and described with reference to the particular embodiments thereof, it will be understood by those skilled in the art that various changes in form and details may be effected therein without departing from the spirit and scope of the invention as defined by the appended claims.

What is claimed is:

1. In an automatic mixing cosmetic material vessel having an upper case 60, a lower case 70 and a discharge pump 80 disposed at a position above the upper case 60, in which a first and a second chambers 71, 72 for containing contents therein are formed in the lower case 70, parts of discharge tubes 58a, 58b are disposed in the first and the second chambers 71, 72, and a horizontal partition 76 is disposed at an upper inner side of the lower case 70, characterized by comprising:
a circular connecting member 54 being disposed between an inner highest portion of the lower case 70 and the inner lower portion of the upper case 60;
the discharge tubes 58a, 58b extending from the first and the second chambers 71, 72 through an inside of the connecting member 54 into the upper case 60;
the highest upper free ends of the discharge tubes 58a, 58b being inserted into a body 61 of a discharge-quantity control part 62 disposed at an internal center portion of the upper case 60; and
a valve 64 being rotatably disposed between the highest upper free ends of the discharge tubes 58a, 58b within the body 61,
wherein the valve 64 is integrally connected with a dial 66 disposed between the valve 64 and the circular connecting member 54 in such a manner as to operate together with the dial 66, and the valve 64 selectively opens or closes the highest upper ends of the discharge tubes 58a, 58b by receiving a driving force from the dial 66.

2. The automatic mixing cosmetic material vessel as claimed in claim 1, characterized by the fact of an opening 77 being formed through the horizontal partition 76, in which a vacuum prevention cap 78 is fitted into the opening 77 and allows an external air to be introduced into the first chamber 71 and the second chamber 72 and stops the contents from discharging so as to offset an atmospheric air pressure difference being generated during discharging contents from the first and the second chambers 71, 72.

3. The automatic mixing cosmetic material vessel as claimed in claim 2, characterized by the fact of sealing members for preventing the contents in the cosmetic material vessel 50 from leaking being disposed between the upper surfaces of the connecting member 54 and outer circumferential surfaces of the discharge tubes 58a, 58b passing through the inside of the connecting member 54 and between the lower surfaces of the connecting member 54 and outer circumferential surfaces of the discharge tubes 58a, 58b.

4. The automatic mixing cosmetic material vessel as claimed in claim 1, characterized by the fact of a valve 64 having a vertical rotational shaft 65 vertically extending from the lower portion of the valve 64, in which the vertical rotational shaft 65 passes through the inside of the dial 66, the lower end of the rotational shaft 65 is inserted into the circular connecting member 54, whereby the valve 64 can receive a rotational force of the dial 66 via the vertical rotational shaft 65.

5. The automatic mixing cosmetic material vessel as claimed in claim 1, characterized by the fact of the discharge pump 80 being disposed at a predetermined position above the valve 64, in which a part of the discharge pump 80 is exposed to the outside of the upper case 60 and the other is positioned in the upper case 60, a push button 82 is disposed at an upper portion of the discharge pump 80 and a discharge port 81 is formed at a middle portion of the push button 82, in which the push button 82 is elastically supported by a coil spring 83 disposed in a neck portion of the upper case 60, a content discharge passageway 84 is formed in the push button 82, the lower portion of the push button 82 is inserted into a second protrusion 68 upwardly protruding from the body 61 of the discharge-quantity control part 62, thereby the content discharge passageway 84 is communicated with the valve 64 disposed in the body 61.
